(19) United States
(12) Patent Application Publication
(10) Pub. No.: US 2010/0107841 A1
(43) Pub. Date: May 6, 2010

(54) Worktable of a table saw

(75) Inventors: Chia-Sheng Liu, Taichung County (TW); Yu-Feng Chang, Taichung County (TW)

Correspondence Address: BACON & THOMAS, PLLC, 625 SLATERS LANE, FOURTH FLOOR, ALEXANDRIA, VA, 22314-1176, US

(73) Assignee: DURQ MACHINERY CORP., Taichung (TW)

(21) Appl. No.: 12/318,362

(22) Filed: Dec. 29, 2008

(30) Foreign Application Priority Data
Oct. 31, 2008 (TW) 97142117

(51) Int. Cl. B26D 1/18

(52) U.S. Cl. 83/477.2

(57) ABSTRACT

A worktable used in a table saw is disclosed to include a main worktable plate made of iron and having a first opening, and a relatively smaller reinforcing plate made of iron and bonded to the bottom side of the main worktable plate to hold the cutting mechanism of the table saw at the bottom side and having a second opening in vertical alignment with the first opening for the passing of the saw blade of the cutting mechanism.

### BACKGROUND OF THE INVENTION

1. Field of the Invention

The present invention relates to table saws and more specifically to a worktable for table saw.

2. Description of the Related Art

A regular table saw comprises a base, a worktable mounted on the top side of the base, and a cutting mechanism mounted on the bottom side of the worktable. The cutting mechanism comprises a motor, a saw blade and other related members. The worktable is capable of supporting the total weight of the cutting mechanism. Normally, the worktable is made of aluminum, having a certain thickness for protection against deformation.

An aluminum worktable can support the total weight of a cutting mechanism for table saw. However, in order to support the total weight of a cutting mechanism for table saw and to protect against deformation, an aluminum worktable for table saw must be made having a great wall thickness, resulting in a heavy weight of the worktable. Further, increasing the wall thickness of an aluminum worktable relatively increases the consumption of aluminum. In consequence, the cost of the worktable is relatively increased.

Therefore, it is desirable to provide a worktable for table saw that eliminates the aforesaid drawbacks.

### SUMMARY OF THE INVENTION

The present invention has been accomplished under the circumstances in view. It is the main object of the present invention to provide a worktable for table saw, which has high strength and low cost characteristics.

To achieve this and other objects of the present invention, a worktable is used in a table saw, comprising a main worktable plate and a reinforcing plate. The main worktable plate is made of iron, having a first opening for the passing of the saw blade of the cutting mechanism of the table saw. The reinforcing plate is made of iron and bonded to the bottom side of the main worktable plate. The area of the reinforcing plate is relatively smaller than the main worktable plate. Further, the reinforcing plate has a second opening set in alignment with the first opening of the main worktable plate for the passing of the saw blade of the cutting mechanism of the table saw.

By means of the relatively smaller design of the reinforcing plate, the total weight of the worktable can be relatively reduced. Further, by means of reinforcing the main worktable plate with the reinforcing plate, the worktable has a high structural strength, assuring high working stability and operation safety of the table saw.

### BRIEF DESCRIPTION OF THE DRAWING

FIG. 1 is an exploded view of a table saw constructed according to the present invention.

FIG. 2 is an exploded view of a worktable according to the present invention.

FIG. 3 corresponds to FIG. 2 when viewed from the bottom side.

FIG. 4 is an elevational assembly view of the worktable according to the present invention.

FIG. 5 is a bottom view of the worktable shown in FIG. 4.

FIG. 6 is a sectional view of the worktable according to the present invention.

FIG. 7 is a schematic drawing of the present invention, showing an adjustment operation of the swinging member of the cutting mechanism of the table saw.

FIG. 8 is a schematic sectional view of the present invention, showing the arrangement of the suspension arm supporting structure.

### DETAILED DESCRIPTION OF THE INVENTION

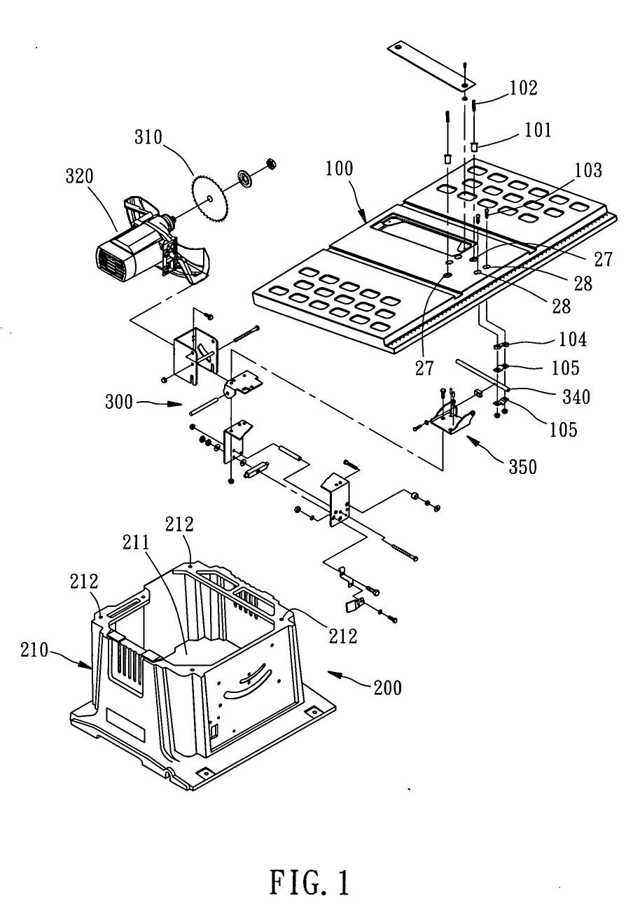

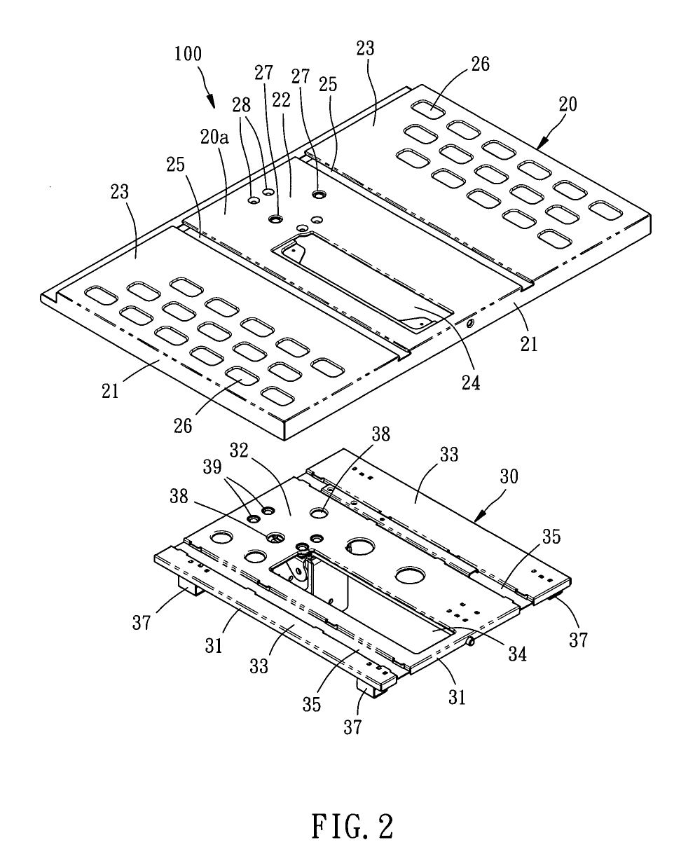

Referring to FIGS. 1˜6, a worktable 100 in accordance with the preferred embodiment of the present invention is mounted on the top side of a base 210 of a table saw 200. The worktable 100 has its bottom side configured for the mounting of a cutting mechanism 300, which comprises a saw blade 310, a motor 320, a suspension arm 340, and a swinging member 350. The worktable 100 comprises a main worktable plate 20, a reinforcing plate 30, four rib members 40, and two braces 50.

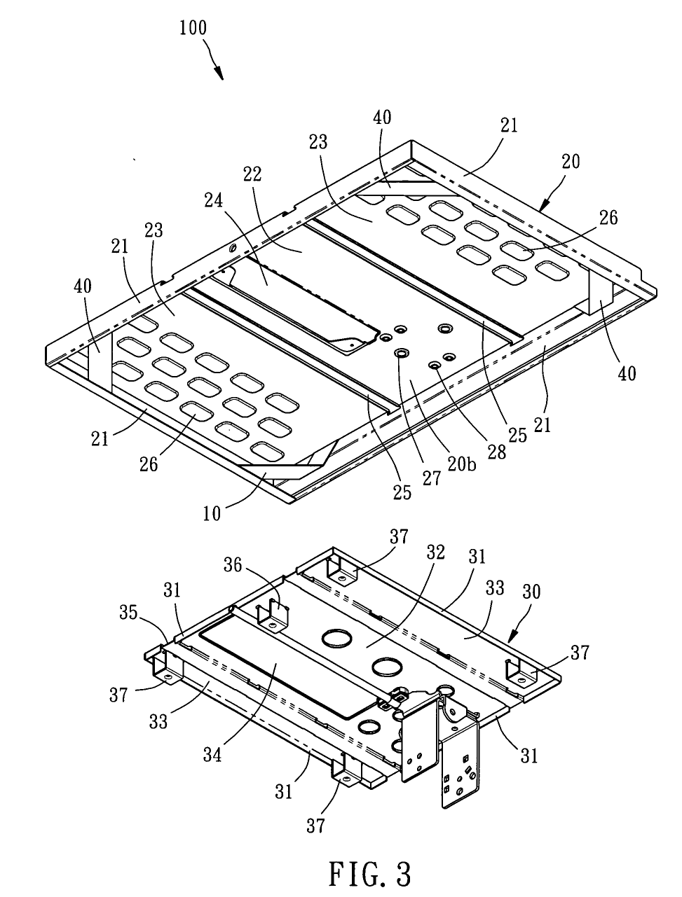

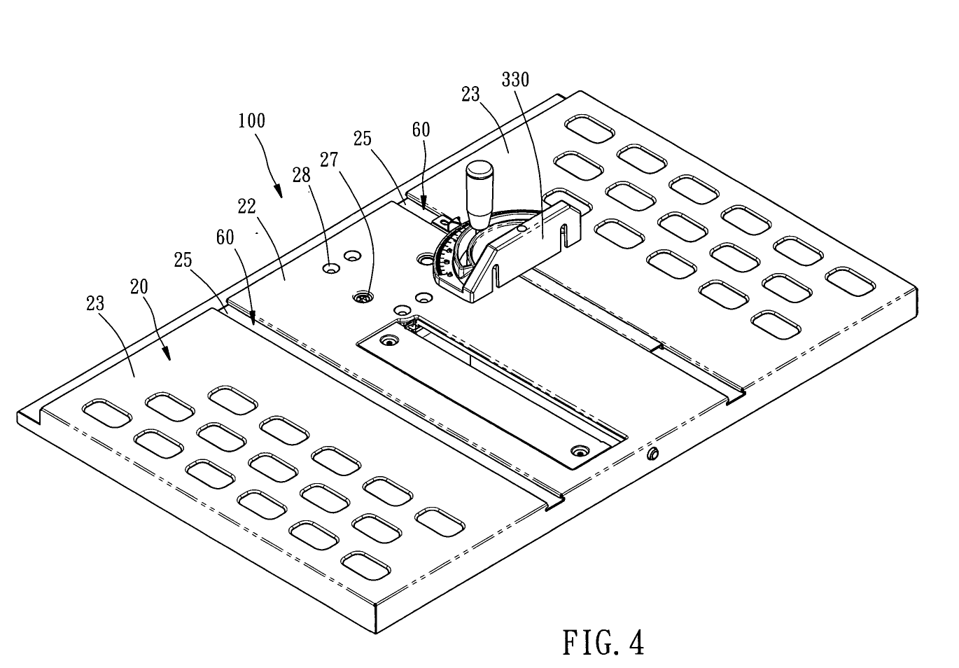

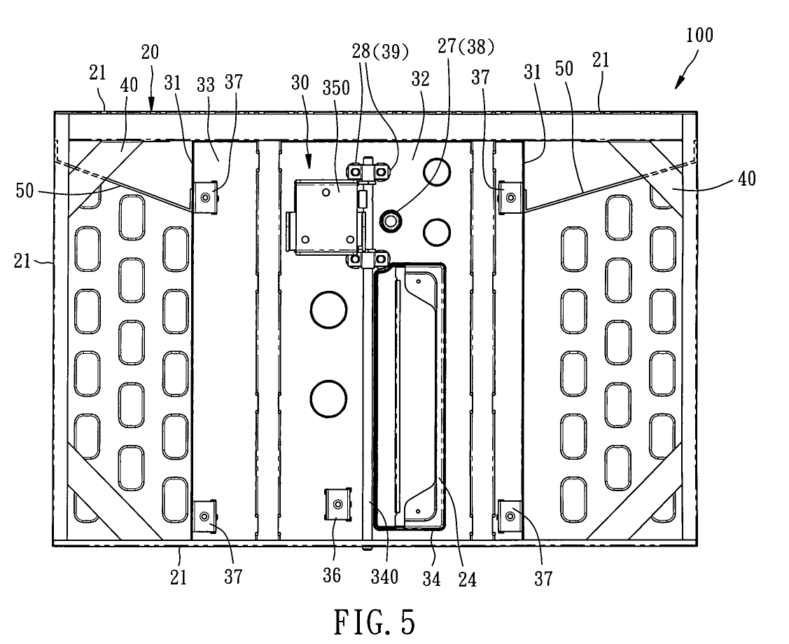

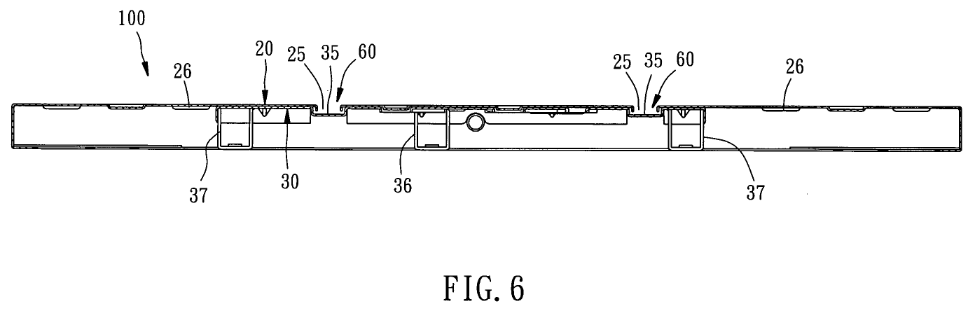

The main worktable plate 20 is a flat rectangular iron plate worked through stamping and bending processes, having a top surface 20a, a bottom surface 20b, and a downwardly extending peripheral flange 21 at each of the four sides. Further, the main worktable plate 20 is divided into a work region 22 on the middle, and two extension regions 23 at two opposite sides relative to the work region 22. The working region 22 has formed therein a first opening 24, two first punch holes 27, and four first through holes 28. Further, an elongated slot 25 extends along the connection area between the work region 22 and each extension region 23. Further, each extension region 23 has a plurality of recessed portions 26 curved inwards in the top surface 20a to enhance the tensile strength of the respective extension region 23. Further, the four rib members 40 are respectively connected between each two adjacent peripheral flanges 21, as shown in FIGS. 3 and 5, enhancing the tensile strength of the border area of the main worktable plate 20.

The reinforcing plate 30 is a flat rectangular iron plate worked through stamping and bending processes, having a downwardly extending peripheral flange 31 at each of the four sides. The area of the reinforcing plate 30 is smaller than the main worktable plate 20 Further, the reinforcing plate 30 is divided into a middle reinforcing region 32 that has an area approximately equal to the area of the work region 22, and two lateral wing regions 33 that are disposed at two opposite sides relative to the middle reinforcing region 32 and have an area relatively smaller than the extension regions 23. The reinforcing plate 30 is bonded to the bottom surface 20b of the reinforcing plate 30 by spot welding, thereby reinforcing the work region 22 with the reinforcing region 32 and the extension regions 23 with the respective wing regions 33. Therefore, the worktable 100 has a high structural strength, facilitating cutting operation. Further, the reinforcing region 32 has formed therein a second opening 34 corresponding to the first opening 24 for enabling the saw blade 310 to pass through the first and second openings 24 and 34, two second punch holes 38 corresponding to the first punch holes 27, and four second through holes 39 corresponding to the first through holes 28.

Further, the reinforcing plate 30 has a recessed portion 35 at the connection area between the reinforcing region 32 and each wing region 33. Each recessed portions 35 constitutes with the corresponding elongated slot 25 a sliding track 60 for the mounting of a rib fence 330 for enabling the rib fence 330 to move along the sliding track 60.

Further, the two braces 50 are connected between the peripheral flanges 21 of the main worktable plate 20 and the peripheral flanges 31 of the reinforcing plate 30 and respectively arranged perpendicular to the rib members 40, thereby enhancing the structural strength of the worktable 100. According to the present preferred embodiment, the two braces 500 are obliquely connected between the two peripheral flanges 21 at the two opposite lateral sides of the main worktable plate 20 and the two peripheral flanges 31 at the two opposite lateral sides of the reinforcing plate 30.

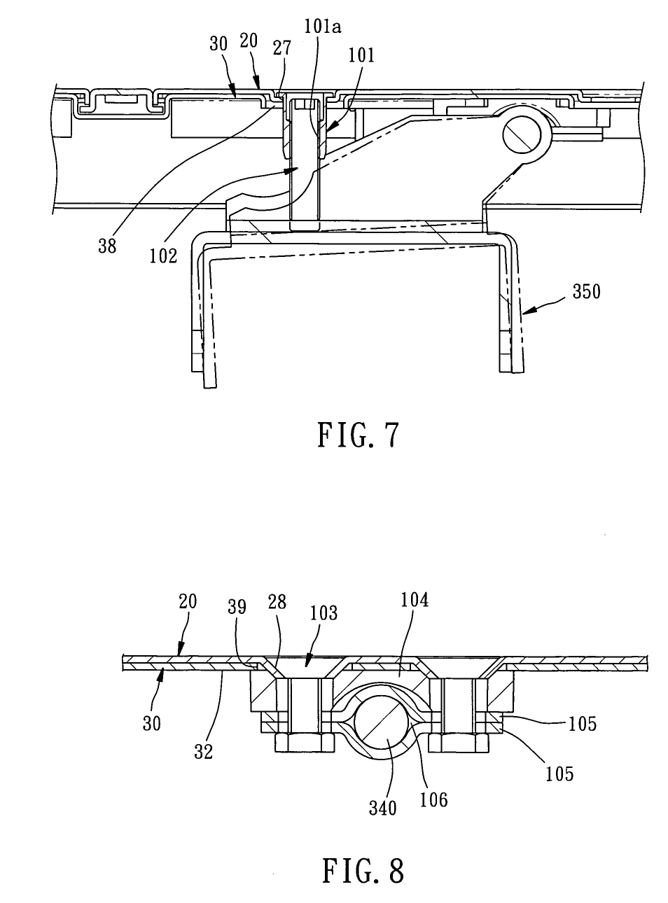

Subject to the aforesaid arrangement, the worktable 100 is strong and steady table saw 200. The bottom wall of the reinforcing plate 30 is provided for the mounting of the cutting mechanism 300 of the table saw 200. As shown in FIG. 7, a plunger 101 can be inserted through one first punch hole 27 and the corresponding second punch hole 28, and a screw bolt 102 is threaded into a screw hole 101a in the plunger 101 and stopped against the swinging member 350 of the cutting mechanism 300. The swinging member 350 is connected with the saw blade 310. By means of rotating the screw bolt 102 inwards or outwards to adjust the swinging angle 350 (see the imaginary line in FIG. 7), the tilting angle of the saw blade 310 of the cutting mechanism 300 is relatively adjusted.

Further, two screw bolts 103 are inserted through the first through holes 28 and the second through holes 39 to fix a nonmetallic cushion block 104 and two packing plates 105 to the bottom side of the reinforcing region 32 of the reinforcing plate 30. The two packing plates 105 define therebetween a receiving hole 106 for the passing of the suspension arm 340 of the cutting mechanism 300. By means of the flexibly deformable material property of the nonmetallic cushion block 104, the suspension arm 340 is firmly secured in place.

Further, except the installation of the suspension arm 340 and the swinging member 350 in the bottom side of the reinforcing plate 30, the bottom side of the reinforcing plate 30 is provided with one or a number of brackets 36 for the fastening of other component parts of the cutting mechanism 300. The number of the brackets 36 is determined subject to the number of component parts of the cutting mechanism 300 to be affixed.

The connection between the base 210 and the worktable 100 is outlined hereinafter.

The base 210 is a hollow shell defining an accommodation open chamber 211 and having a screw hole 212 in each of the four corners of the top side.

The reinforcing plate 30 of the worktable 100 has four mounting lugs 37 provided at the bottom side of the wing regions 33 corresponding to the four screw holes 212 of the base 210. Screws (not shown) are respectively inserted through the mounting lugs 37 and threaded into the screw holes 212 to affix the worktable 100 to the top side of the base 210. After installation, the cutting mechanism 300 is received in the accommodation open chamber 211 of the base 210.

As stated above, the worktable 100 is designed to bond a relatively smaller reinforcing plate 30 of iron to a relatively greater main worktable plate 20 of iron, reducing the total weight and enhancing the structural strength and load-carrying ability. Therefore, the worktable 100 can support the cutting mechanism and the workpiece steadily against deformation. Further, using iron to make the worktable saves much material cost when compared to the use of aluminum. In conclusion, the worktable 100 has low weight and high strength characteristics practical for use in a complicated table saw, assuring high working stability and operation safety of the table saw.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A worktable used in a table saw to hold a cutting mechanism at a bottom side thereof, the worktable comprising:
a main worktable plate made of iron, said main worktable plate comprising a top surface, a bottom surface opposite to said top surface, a first opening cut through said top surface and said bottom surface for the passing of a saw blade of said cutting mechanism; and
a reinforcing plate made of iron, said reinforcing plate comprising a top wall bonded to the bottom surface of said main worktable plate, a bottom wall for the mounting of said cutting mechanism, and a second opening cut through said top wall and said bottom wall in alignment with said first opening for the passing of said saw blade of said cutting mechanism.

2. The worktable as claimed in claim 1, wherein said main worktable plate comprises a work region, said work region having formed therein said first opening, two extension regions at two opposite sides of said work region, and two elongated slots respectively formed in between said work region and each of said extension regions; said reinforcing plate has an area smaller than the area of said main worktable plate, comprising a reinforcing region corresponding to said work region in size, said reinforcing region having said second opening formed therein, two wing regions at two opposite sides of said reinforcing region, each said wing region having an area smaller then each said extension region, and a recessed portion respectively formed in between said reinforcing region and each of said wing region, each said recessed portion constituting with one said elongated slot of said main worktable plate a respective sliding track.

3. The worktable as claimed in claim 2, wherein said main worktable plate comprises a plurality of recessed portions formed in said extension regions.

4. The worktable as claimed in claim 1, wherein said main worktable plate comprises a plurality of peripheral flanges respectively downwardly extended from peripheral sides thereof, and a plurality of rib plates respectively connected between each two adjacent peripheral flanges.

5. The worktable as claimed in claim 1, wherein said main worktable plate comprises a plurality of peripheral flanges respectively downwardly extended from peripheral sides thereof; said reinforcing plate comprises a plurality of peripheral flanges respectively downwardly extended from peripheral sides thereof and connected to the peripheral flanges of said main worktable plate with braces.

6. The worktable as claimed in claim 2, wherein said reinforcing plate comprises a plurality of mounting lugs respectively provided at a bottom wall of each said wing region for fastening to a base of said table saw.

7. The worktable as claimed in claim 1, wherein said reinforcing plate comprises at least one bracket located on a bottom side of said reinforcing region for the mounting of at least one component part of said cutting mechanism.

8. The worktable as claimed in claim 1, wherein said reinforcing plate comprises a cushion block mounted on a bottom side of said reinforcing region, and at least one packing plate fastened to said cushion block to support a suspension arm of said cutting mechanism.

9. The worktable as claimed in claim 1, further comprising at least one first punch hole formed in said main worktable plate, at least one second punch hole formed in said reinforcing plate corresponding to said at least one first punch hole, a plunger insertable into one said first punch hole and the corresponding second punch hole, said plunger comprising a screw hole, and a screw bolt threaded into said screw hole of said plunger and stopped against a swinging member of said cutting mechanism.
